(19) United States
(12) Patent Application Publication
(10) Pub. No.: US 2006/0074771 A1
(43) Pub. Date: Apr. 6, 2006

(54) Method and apparatus for category-based photo clustering in digital photo album

(75) Inventors: Sangkyun Kim, Yongin-si (KR); Jiyeun Kim, Seoul (KR); Youngsu Moon, Seoul (KR); Yongman Ro, Daejeon-si (KR); Seungji Yang, Wonju-si (KR)

Correspondence Address: STEIN, MCEWEN & BUI, LLP, 1400 EYE STREET, NW, SUITE 300, WASHINGTON, DC, 20005, US

(73) Assignees: Samsung Electronics Co., Ltd., Suwon-si (KR); Research and Industrial Cooperation Group, Daejeon-si (KR)

(21) Appl. No.: 11/242,533

(22) Filed: Oct. 4, 2005

(30) Foreign Application Priority Data
Oct. 4, 2004 (KR) 10-2004-0078756

(51) Int. Cl. G06Q 30/00

(52) U.S. Cl. 705/26

(57) ABSTRACT

A method of category-based clustering of a digital photo album and a system thereof, the method includes: generating photo information by extracting at least one of camera information of a camera used to take a photo, photographing information, and a content-based feature value including at least one of color, texture, and shape feature values, and a speech feature value; generating a predetermined parameter including at least one of user preference indicating the personal preference of the user, photo semantic information generated by using the content-based feature value of the photo, and photo syntactic information generated by at least one of the camera information, the photographing information, and interaction with the user; generating photo group information categorizing photos by using the photo information and the parameter; and generating a photo album by using the photo information and the photo group information. According to the method and system, by using together user preference and content-based feature value information, such as color, texture, and shape, from the contents of photos, as well as information that can be basically obtained from photos, such as camera information and file information stored in a camera, a large volume of photos are effectively categorized such that an album can be fast and effectively generated with photo data.

### CROSS-REFERENCE TO RELATED APPLICATION

This application claims the benefit of Korean Patent Application No. 2004-78756, filed on Oct. 4, 2004 in the Korean Intellectual Property Office, the disclosure of which is incorporated herein in its entirety by reference.

### BACKGROUND OF THE INVENTION

1. Field of the Invention

An aspect of the present invention relates to a digital photo album, and more particularly, to a method of category-based clustering a digital photo for a digital photo album.

2. Description of the Related Art

Because a digital camera does not use a film and does not require a film printing process to view a photo, unlike an analog camera, and can store and delete contents any time using a digital memory device, digital cameras have become more popular. Also, since the performance of the digital camera has improved and at the same time the size has been decreased, users can carry digital cameras and take photos anytime, and at anyplace. With the development of digital image processing technologies, a digital camera image is approaching the picture quality of the analog camera, and users can share digital contents more freely because of easier storage and transmission of the digital contents. Accordingly, the use of digital cameras is increasing. This increase in demand for digital cameras causes the price of the cameras to fall, and as a result, the demand for digital cameras increases.

In particular, with the recent development of memory technologies, highly-integrated ultra-small-sized memories are now widely used, and with the development of digital image compression technologies that do not compromise picture quality, users can now store hundreds to thousands of photos in one memory. As a result, apparatuses and tools for effectively managing more photos are needed. Accordingly, users' demand for efficient digital photo albums is increasing. In general, a digital photo album is used to transfer photos taken by a user from a digital camera or a memory card to a local storage apparatus of the user and to manage the photos in a computer. By using the photo album, users index many photos in a time series or in photo categories arbitrarily made by the users and browse the photos according to the index, or share the photos with other users.

In Requirement for photoware (ACM CSCW, 2002), David Frohlich investigated the function of a photo album required by users through a survey. Most interviewees agreed with the necessity of a digital photo album, but felt that the time and efforts taken for grouping or labeling many photos one by one were inconvenient factors, and expressed difficulties in sharing photos with others. Thus, the category arbitrarily made by a user is very inefficient for the user to make footnotes one by one, especially when the volume of photos is large.

In the related research and systems of the initial stage, photos were grouped by using only time information on a time when a photo was taken. As a leading research, there was Adrian Graham's “Time as essence for photo browsing through personal digital libraries”, (ACM JCDL, 2002). In this research, by using only the taken time, photos can be grouped roughly. However, this method cannot be used when a photo is taken without storing time information or time information is lost later during photo editing processes.

Content-based feature value of a photo is a method to solve problems of photo grouping by using only time information. Much research has been conducted using time information of photos and content-based feature values together. A representative method is one by Alexander C. Loui, “Automated event clustering and quality screening of consumer pictures for digital albuming (IEEE Transaction on Multimedia, vol. 5, No. 3, pp. 390-401, 2003)”, which suggests a method clustering a series of photos based on events by using time and color information of photos. However, since only color histogram information of a photo is used as a content-based feature value, it is very sensitive to brightness changes and it is difficult to sense changes in texture and shapes.

Today, most digital photo files comply with an exchangeable image file (EXIF) format. EXIF header includes photographing information such as information on a time when a photo is taken, and camera status information. Also, with the name of MPEG-7, ISO/IEC/JTC1/SC29/WG11 is standardizing element technologies required for content-based search in a description scheme to express a descriptor and the relations between a descriptor and a description scheme. A method for extracting content-based feature values such as color, texture, shape, and motion is suggested as a descriptor. In order to model contents, the description scheme defines the relation between two or more descriptors and the description scheme and defines how data is to be expressed.

Accordingly, if various metadata information and content-based feature values of photos are used together, more effective photo grouping and searching can be performed. However, so far, a description scheme to express integrally this variety of information items, that is, information at the time when a photo is taken, photo syntactic information, photo semantic information, and user preference, and a photo albuming method and system providing photo categorization to which the description scheme is applied do not exist.

### SUMMARY OF THE INVENTION

An aspect of the present invention provides a method of and a system for category-based photo clustering in a digital photo album, by which a large volume of photos are effectively categorized by using together user preference and content-based feature value information, such as color, texture, and shape, from the contents of photos, as well as information that can be basically obtained from photos, such as camera information and file information stored in a camera.

According to another aspect of the present invention, there is provided a method of category-based clustering in a digital photo album, including: generating photo information by extracting at least one of camera information of a camera used to take a photo, photographing information, and a content-based feature value including at least one of color, texture, and shape feature values, and a speech feature value; generating a predetermined parameter including at least one of user preference indicating the personal preference of the user, photo semantic information generated by using the content-based feature value of the photo, and photo syntactic information generated by at least one of the camera information, the photographing information, and interaction with the user; generating photo group information categorizing photos using the photo information and the parameter; and generating a photo album using the photo information and the photo group information.

According to another aspect of the present invention, there is provided a method of category-based clustering in a digital photo album, including: generating photo description information describing a photo and including at least a photo identifier; generating albuming tool information supporting photo categorization and including at least a predetermined parameter for photo categorization; categorizing photos using input photos, the photo description information and the albuming tool description information; generating the categorized result as predetermined photo group description information; and generating predetermined album information using the photo description information and the photo group description information.

According to another aspect of the present invention, the generating of the photo description information may include: extracting the camera information of the camera used to take the photo and the photographing information of the photographing from a photo file; extracting a predetermined content-based feature value from the pixel information of the photo; and generating predetermined photo description information by using the extracted camera information, photographing information and content-based feature value. The content-based feature value may include: a visual descriptor including color, texture, and shape feature values; and an audio descriptor including a speech feature value. The photo description information may include at least a photo identifier among the photo identifier, information on the photographer taking the photo, photo file information, the camera information, the photographing information, and the content-based feature value.

According to another aspect of the present invention, the photo file information may include at least one of a file name, file format, file size, and file creation date, and the camera information may include at least one of information (IsEXIFInformation) indicating whether or not the photo file includes EXIF information, and information (Camera model) indicating the camera model used to take the photo. The photographing information may include at least one of information (Taken date/time) indicating the date and time when the photo is taken, information (GPS information) indicating the location where the photo is taken, photo with information (Image width), photo height information (Image height), information (Flash on/off) indicating whether or not a camera flash is used to take the photo, brightness information of the photo (Brightness), contrast information of the photo (Contrast), and sharpness information of the photo (Sharpness).

According to another aspect of the present invention, in the generating of the albuming tool information, the albuming tool description information may include at least one of: a category list indicating semantic information to be categorized; and a category-based clustering hint to help photo clustering. The category-based clustering hint may include at least one of: a semantic hint generated by using the content-based feature value of the photo; a syntactic hint generated by at least one of the camera information, the photographing information and the interaction with the user; and a user preference hint.

According to another aspect of the present invention, the category list may include at least one of mountain, waterside, human-being, indoor, building, animal, plant, transportation, and object.

According to another aspect of the present invention, the semantic hint may be semantic information included in the photo, the information expressed by using nouns, adjectives, and adverbs.

According to another aspect of the present invention, the syntactic hint may include at least one of: a camera hint indicating the camera information at the time of photographing; an image hint including at least one of information (Photographic composition) on a composition formed by objects of the photo, information (Region of interest) on the number of main interest areas in the photo and the location of each area, and a relative compression ratio (Relative compression ratio) in relation to the resolution of the photo; and an audio hint including keywords (Speech info) describing speech information extracted from an audio clip.

According to another aspect of the present invention, the camera hint may be based on EXIF information stored in a photo file and may include at least one of a photographing time (Taken time), information (Flash info) on whether or not a flash is used, information (Zoom info) on whether or not a camera zoom is used and the zoom distance, a camera focal length (Focal length), a focused region (Focused region), an exposure time (Exposure time), information (Contrast) on contrast basically set for the camera, information (Brightness) on brightness basically set for the camera, GPS information (GPS info), text annotation information (Annotation), and camera angle information (Angle).

According to another aspect of the present invention, the user preference hint may include: category preference information (Category preference) describing the preference of the user on the categories in the category list.

According to another aspect of the present invention, the categorizing of the photos may include: generating a new feature value by applying the category-based clustering hint to the extracted content-based feature value; measuring similarity distance values between the new feature value and feature values in a predetermined category feature value database; and determining one or more categories satisfying a condition that the similarity distance value is less than a predetermined threshold, as final categories.

According to another aspect of the present invention, semantic hint, syntactic hint and user preference hint values may be extracted and the value of the category-based clustering hint may be expressed as the following equation:
Vₕᵢₙₜ(i)={V_{semantic}(i), V_{syntactic}(i), Vᵤₛₑᵣ}

where V_{semantic}(i) denotes the semantic hint extracted from the i-th photo, V_{syntactic}(i) denotes the syntactic hint extracted from the i-th photo, and Vᵤₛₑᵣ(i) denotes the user category preference hint.

According to another aspect of the present invention, in the user preference hint value extraction, a category to which sets of input query photo data belong may be selected according to the memory of the user, the importance degree of each category may be input, and the category preference hint of the user may be expressed as the following equation:
Vᵤₛₑᵣ={β₁,β₂,β₃, . . . ,β_{c}, . . . ,β_{C}}

where β_{c} is a value denoting the preference degree of the user on the c-th category and has a value between 0.0 to 1.0 inclusive, and a method of selecting a category by the above equation may be expressed as the following equation:
S_{category}^{selected}={β₁S₁,β₂S₂,β₃S₃, . . . ,β_{c}S_{c}, . . . ,β_{C}S_{C}}

where S_{c} denotes the c-th category, and if β_{c} is 0.0, the category is not selected, and if β_{c} is close to 0.0, the category is selected but it indicates the user preference of the category is low. If β_{c} is close to 1.0, it indicates that the user preference of the selected category is high.

According to another aspect of the present invention, in the extraction of the syntactic hint value, by using the EXIF information, image composition information, and audio clip information stored in the camera, a semantic hint value may be extracted and the semantic hit extracted from an i-th photo may be expressed as the following equation:
V_{syntactic}(i)={V_{camera}, V_{image}, V_{audio}}

where V_{camera} denotes a set of syntactic hints including camera information and photographing information, V_{image} denotes a set of syntactic hints extracted from photo data itself, and V_{audio} denotes a set of syntactic hint values extracted from the audio clip stored together with photos.

According to another aspect of the present invention, in the extraction of the semantic hint value, a semantic hint value included in the contents of the photo may be extracted in a j-th area of the i-th photo, and may be expressed as the following equation:
V_{semantic}(i,j)={V₁, V₂, V₃, . . . , V_{M}} where Vₘ=(νₘ^{adverb}, νₘ^{adjective}, νₘ^{noun}, αₘ)

where Vₘ denotes an m-th semantic hint value extracted in the j-th area of the i-th photo, νₘ^{noun} denotes the m-th noun hint value, νₘ^{adverb} denotes the m-th adverb hint value, νₘ^{adjective} denotes the m-th adjective hint value, and αₘ denotes a value indicating the importance of the m-th semantic hint value, and has a value between 0.0 and 1.0 inclusive.

According to another aspect of the present invention, in relation to the content-based feature value, by using the extracted category hint information items, an image may be localized and from each area, multiple content-based feature values may be extracted and multiple content-based feature values in a j-th area of the i-th photo may be expressed as the following equation:
F_{content}(i,j)={F₁(i,j),F₂(i,j),F₃(i,j), . . . ,F_{N}(i,j)}

where Fₖ(i,j) denotes a k-th feature value vector in the j-th area of the i-th photo.

According to another aspect of the present invention, in the generating of the new feature value, the new feature value may be expressed as the following equation:
F_{combined}(i)=Φ{Vₕᵢₙₜ(i), F_{content}(i)}

where function Φ(·) is a function generating a feature value by using together Vₕᵢₙₜ(i), the category-based clustering hint of the i-th photo, and F_{content}(i), the content-based feature value of the i-th photo. In the measuring of the similarity distance value, the similarity distance value may be expressed as the following equation:
D(i)={D₁(i), D₂(i), D₃(i), . . . D_{C}(i)}

where D_{c}(i) denotes the similarity distance value between the c-th category and the i-th photo. In the determining one or more categories, the condition may be expressed as the following equation:
S_{target}(i)⊂{S₁,S₂,S₃, . . . ,S_{C}}, subject to D_{S}_{_{c}}(i)≦th_{D}

where {S1, S2, S3, . . . , Sc} denotes a set of categories, thD denotes a threshold of a similarity distance value for determining a category, and Starget(i) denotes a set of categories satisfying the condition and indicates the category of the i-th photo.

According to another aspect of the present invention, in the generating of the categorized result as the predetermined photo group description information, the photo group description information may include: a category identifier generated by referring to the category list; and a series of photos formed with a plurality of photos determined by the photo identifier.

According to still another aspect of the present invention, there is provided an apparatus for category-based clustering in a digital photo album, including: a photo description information generation unit generating photo description information describing a photo and including at least a photo identifier; an albuming tool description information generation unit generating albuming tool description information supporting photo categorization and including at least a predetermined parameter for photo categorization; an albuming tool performing photo albuming including photo categorization by using at least the photo description information and the albuming tool description information; a photo group information generation unit generating the output of the albuming tool as predetermined photo group description information; and a photo album information generation unit generating predetermined album information by using the photo description information and the photo group description information.

According to another aspect of the present invention, the photo description information may include at least a photo identifier among the photo identifier, information on the photographer taking the photo, photo file information, the camera information, the photographing information, and the content-based feature value, and the content-based feature value may be generated by using pixel information of a photo and may include: a visual descriptor including color, texture, and shape feature values; and an audio descriptor including a speech feature value.

According to another aspect of the present invention, the albuming tool description information generation unit may include at least one of: a category list generation unit generating a category list indicating semantic information to be categorized; and a clustering hint generation unit generating a category-based clustering hint to help photo clustering, and the category-based clustering hint generation unit may include at least one of: a semantic hint generation unit generating a semantic hint by using the content-based feature value of the photo; a syntactic hint generation unit generating a syntactic hint by at least one of the camera information, the photographing information and the interaction with the user; and a preference hint generation unit generating the preference hint of the user.

According to another aspect of the present invention, the category list of the category list generation unit may include at least one of mountain, waterside, human-being, indoor, building, animal, plant, transportation, and object.

According to another aspect of the present invention, the semantic hint of the semantic hint generation unit may be semantic information included in the photo, the information expressed by using nouns, adjectives, and adverbs. The syntactic hint of the syntactic hint generation unit may include at least one of: a camera hint indicating the camera information at the time of photographing; an image hint including at least one of information (Photographic composition) on a composition formed by objects of the photo, information (Region of interest) on the number of main interest areas in the photo and the location of each area, and a relative compression ration (Relative compression ratio) in relation to the resolution of the photo; and an audio hint including keywords (Speech info) describing speech information extracted from an audio clip.

According to another aspect of the present invention, the albuming tool may include a category-based photo clustering tool clustering digital photo data based on the category. The category-based photo clustering tool may include: a feature value generation unit generating a new feature value, by using the content-based feature value generated in the photo description information generation unit and the category-based clustering hint generated in the albuming tool description information generation unit; a feature value database extracting in advance and storing feature values of photos belonging to a category; a similarity measuring unit measuring similarity distance values between the new feature value and feature values in the feature value database; and a category determination unit determining one or more categories satisfying a condition that the similarity distance value is less than a predetermined threshold, as final categories.

According to another aspect of the present invention, the photo group description information of the photo group information generation unit may include: a category identifier generated by referring to the category list; and a series of photos formed with a plurality of photos determined by the photo identifier.

According to still another aspect of the present invention, there is provided a computer readable recording medium having embodied thereon a computer program for executing the above methods.

According to still another aspect of the present invention, there is provided a camera executing the above methods.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of the structure of a system for category-based photo clustering in a digital album according to an embodiment of the present invention;

FIG. 2 is a detailed block diagram of an albuming tool description information generation unit according to an embodiment of the present invention;

FIG. 3 is a block diagram of the structure of a clustering hint generation unit according to an embodiment of the present invention;

FIG. 4 is a block diagram of the structure of a category-based clustering tool according to an embodiment of the present invention;

FIG. 5 illustrates the structure of photo description information generated in a photo description information generation unit according to an embodiment of the present invention;

FIG. 6 illustrates a description scheme showing parameters required for photo categorization using photo description information according to an embodiment of the present invention;

FIG. 7 is a block diagram showing semantic hint information among hint information items required for photo categorizing described in FIG. 6;

FIG. 8 is a block diagram showing syntactic hint information among hint information items required for effective photo categorizing described in FIG. 6;

FIG. 9 is a block diagram showing user preference hint information among hint information items required for effective photo categorizing described in FIG. 6;

FIG. 10 is a block diagram showing a description scheme to express photo group information after clustering photos according to an embodiment of the present invention;

FIG. 11 is a block diagram showing a photo information description scheme according to an embodiment of the present invention expressed in an XML schema;

FIG. 12 is a block diagram showing a parameter description scheme for photo albuming according to an embodiment of the present invention expressed in an XML schema;

FIG. 13 is a block diagram showing a photo group description scheme according to an embodiment of the present invention expressed in an XML schema;

FIG. 14 is a block diagram showing an entire description scheme for digital photo albuming according to an embodiment of the present invention expressed in an XML schema;

FIG. 15 is a flowchart of the operations performed by a method of category-based photo clustering according to an embodiment of the present invention;

FIG. 16 is a detailed flowchart of the operations performed in operation 1500 of FIG. 15;

FIG. 17 is a detailed flowchart of the operations performed in operation 1530 of FIG. 15;

FIG. 18 illustrates a method of category-based clustering an arbitrary photo according to an embodiment of the present invention; and

FIG. 19 illustrates an example of using a category hint according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

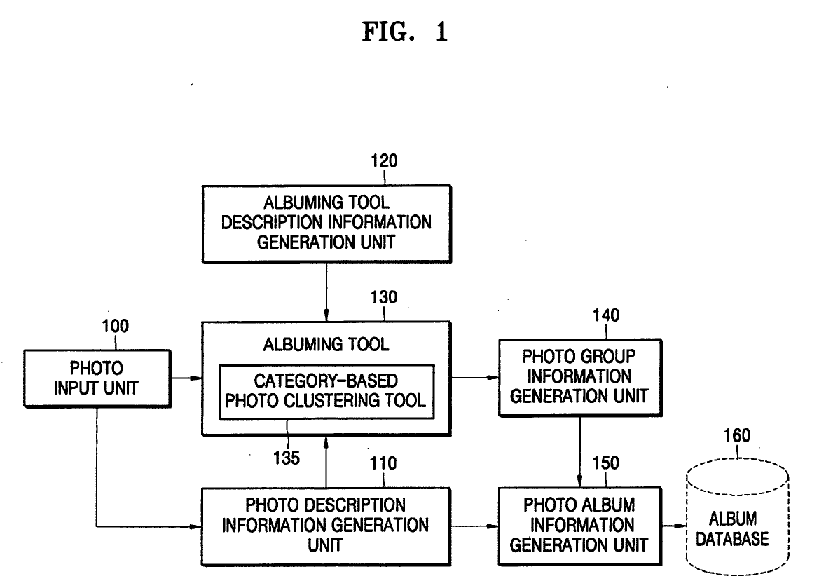

FIG. 1 illustrates the structure of a system for category-based photo clustering in a digital album according to an embodiment of the present invention. The system includes a photo description information generation unit 110, an albuming tool description information generation unit 120, an albuming tool 130, a photo group information generation unit 140, and a photo albuming information generation unit 150. Preferably, the system further includes a photo input unit 100.

The photo input unit 100 receives an input of a series of photos from an internal memory apparatus of a digital camera, or from a portable memory apparatus. Inputting of the photos is not limited to the internal memory apparatus or to the portable memory apparatus but the photos may also be input from an external source through a wire or a wireless communication, or from media such as memory cards and disks.

The photo description information generation unit 110 generates photo description information describing a photo and including at least a photo descriptor. More specifically, the photo description information generation unit 110 confirms from each of input photos whether or not there are camera information and photographing information stored in a photo file, and if the information items are in a photo file, the information items are extracted and expressed according to a photo description scheme. At the same time, content-based feature values are extracted from the pixel information of a photo and expressed according to the photo description scheme. The photo description information is input to the photo albuming tool 130 for grouping photos.

In order to more efficiently retrieve and group photos using the variety of generated photo description information items, the albuming tool description information generation unit 120 generates albuming tool description information including predetermined parameters supporting photo categorization and at least for photo categorization.

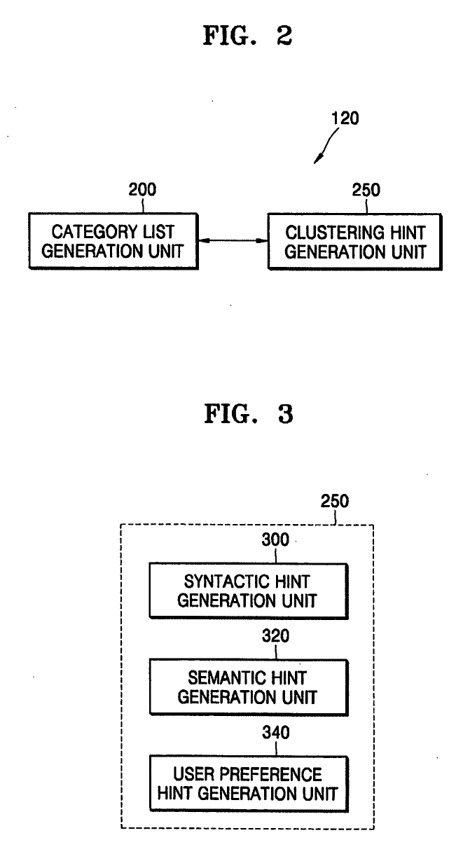

FIG. 2 is a detailed block diagram of the albuming tool description information generation unit 120. The albuming tool description information generation unit 120 includes at least one of a category list generation unit 200 and a clustering hint generation unit 250.

The category list generation unit 200 generates a category list indicating semantic information to be categorized. The clustering hint generation unit 250 generates category-based clustering hints to help photo clustering, and includes at least one of a syntactic hint generation unit 300, a semantic hint generation unit 320, and a preference hint generation unit 340 as shown in FIG. 3.

The syntactic hint generation unit 300 generates syntactic hints by at least one of the camera information, photographing information, and interaction with the user. The semantic hint generation unit 320 generates semantic hints by using the content-based feature values of the photos. The preference hint generation unit 340 generates user preference hints.

The albuming tool 130 performs photo albuming including photo categorization by using at least the photo description information and the albuming tool description information, and includes a category-based clustering tool 135.

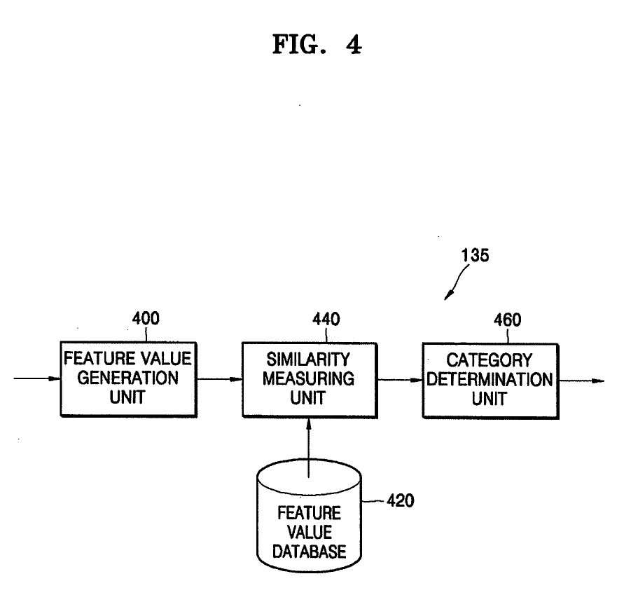

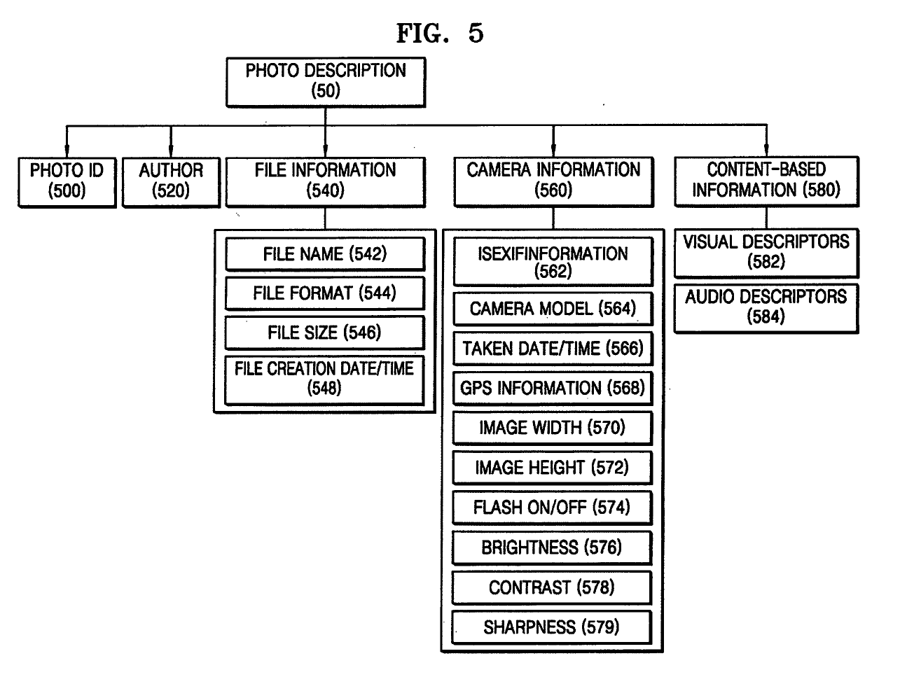

The category-based clustering tool 135 clusters digital photo data based on categories, and includes a feature value generation unit 400, a feature value database 420, similarity measuring unit 440, and a category determination unit 460 as shown in FIG. 4.

The feature value generation unit 400 generates a new feature value by using the content-based feature values generated in the photo description information generation unit 110 and the category-based clustering hint generated in the albuming tool description information generation unit 120. The feature value database 420 extracts in advance and stores feature values of photos belonging to respective categories. The similarity measuring unit 440 measures a similarity distance value between the new feature value generated in the feature value generation unit 400 and feature values in the category feature value database 440. As a final category, the category determination unit 460 determines one or more categories satisfying a condition that the similarity distance value is less than a predetermined threshold.

The photo group information generation unit 140 generates the output of the albuming tool 130 as predetermined photo group description information.

The photo album information generation unit 150 generates predetermined photo album information by using the photo description information and the photo group description information.

FIG. 5 illustrates the structure of photo description information generated in the photo description information generation unit 110. From photos input from an internal memory apparatus of a digital camera or a portable memory apparatus, the photo description information expresses camera information and photographing information stored in a file and content-based feature value information extracted from the contents of photos. As shown in FIG. 5, the photo information description information 50 includes a photo identifier (Photo ID) 500 identifying each photo, an item (Author) 520 expressing an author taking the photo, an item (File information) 540 expressing file information stored in a photo file, an item (Camera information) 560 expressing camera information stored in a photo file, and an item (Content-based information) 580 expressing a content-based feature value.

As detailed items to express the file information 540 stored in a photo file, the photo information description information 50 also includes an item (File name) 542 expressing the name of a photo file, an item (File format) 544 expressing the format of a photo file, an item (File size) 546 expressing the capacity of a photo file in units of bytes, and an item (File creation date/time) 548 expressing the date and time when a photo file is created.

As detailed items to express the camera and photographing information 560 stored in a photo file, the photo information description information 50 also includes an item (IsEXIFInformation) 562 expressing whether or not a photo file includes EXIF information, an item (Camera model) 564 expressing a camera model taking a photo, an item (Taken date/time) 566 expressing the date and time when a photo is taken, an item (GPS information) 568 expressing the location where a photo is taken, an item (Image width) 570 expressing the width information of a photo, an item (Image height) 572 expressing the height information of a photo, an item (Flash on/off) 574 expressing whether or not a camera flash is used to take a photo, an item (Brightness) 576 expressing the brightness information of a photo, an item (Contrast) 578 expressing the contrast information of a photo, and an item (Sharpness) 579 expressing the sharpness information of a photo.

Also, the information 580 expressing a content-based feature value extracted from a photo includes an item (Visual descriptor) 582 expressing feature values of color, texture, and shape extracted by using MPEG-7 Visual Descriptor, and an item (Audio descriptor) 584 expressing a feature value of voice extracted by using MPEG-7 Audio Descriptor.

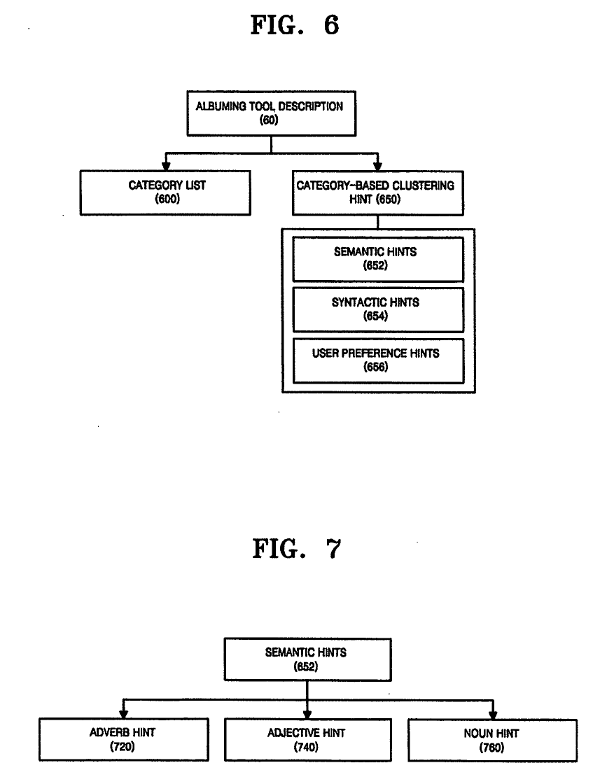

FIG. 6 is a block diagram showing a description scheme to express parameters required for effective photo categorization in a process for categorizing photos using the photo description information 50 described above with reference to FIG. 5. As shown in FIG. 6, an item (Category list) 600 describing a category list to be clustered, and a category-based clustering hint item (Category-based clustering hints) 650 to achieve a higher category-based clustering performance are included as parameters 60 for effective photo categorization.

The item (Category list) 600 describing a category list to be clustered is formed with categories based on meanings of photos. For example, the category list can be formed with ‘mountain’, ‘waterside’, ‘human-being’, ‘indoor’, ‘building’, ‘animal’, ‘plant’, ‘transportation’, ‘object’, and so on, and is not limited to this example.

The categories defined in the category list include semantic information of very high levels. By contrast, content-based feature value information which is extracted from a photo, such as color, shape, and texture, includes semantic information of relatively lower levels. In an aspect of the present invention, in order to achieve a higher category-based clustering performance, category-based clustering hints are defined as described below.

The category-based clustering hint item (Category-based clustering hints) 650 broadly includes an item (Semantic hints) 652 describing meaning-based hints that can be extracted from content-based feature value information of a photo, an item (Syntactic hints) 654 describing hints that can be extracted from forming information of an object in the contents of the photo and camera information and/or photographing information of the photo, or can be extracted from interaction with a user, and a hint item (User preference hints) 656 describing personal preference of the user in categorizing photos.

FIG. 7 is a block diagram showing the semantic hint information among hint information items required for photo categorizing described in FIG. 6. As shown in FIG. 7, the item (Semantic hints) 652 describing meaning-based hints that can be extracted from content-based feature value information of the photo expresses various semantic information included in the photo, in multiple ways by using nouns, adjectives, and adverbs so that a category meaning in a higher level concept can be extracted.

The item (Semantic hints) 652 includes a hint item (Noun hint) 760 expressing the semantic information included in the photo in the form of a noun, an adjective hint item (Adjective hint) 740 restricting a noun hint item, and an adverb hint item (Adverb hint) 720 restricting the degree of an adjective hint item.

The noun hint item (Noun hint) 760 is semantic information at an intermediate level derived from a content-based feature value of a photo, and is semantic information at a level lower than that of upper level semantic information in a category. Accordingly, one category can be expressed again by a variety of noun hint items. Since the semantic information of a noun hint is semantic information at a level lower than category semantic information, it is relatively easier to infer it from content-based feature values. By way of example, the noun hint item can have the following values:
Face, skin, hair, body, crowd
Grass, flower, branch, leaf, tree, wood
Sky, cloud, fog, sun, moon, comet, star, group of star
River, pond, pool, sea, mountain, the bottom of the water
Clay, soil, sand, pebble, stone, brick, rock
Skyscraper, street, road, railroad, pavement, bridge, stairs, billboard
Fire, lamplight, sunlight, flashlight, candle-light, headlight, spotlight
Fabric (textile, weave), iron, plastic, wooden, paper, rubber, vinyl
Door, window, wall, floor, chair, sofa, veranda
Land animal, winged animal
Motorcycle, automobile, bicycle, train, subway
Plane, helicopter, glider
Ship, boat, vessel
Leather, feather, fur, wool, bone
Pattern: check, twill, plain

However, the noun hint item is not limited to these examples and is not limited to English, or Korean such that any language can be used.

The adjective hint item (Adjective hint) 740 is semantic information restricting a noun hint item derived from a content-based feature value of a photo. By way of example, the adjective hint item can have the following values:
Reddish, greenish, bluish
Bright, glary, dark
Small, big (large)
Short, tall
Old (ancient), new (modern)
Low, high
Deep, shallow
Wide, narrow
Thin, thick
Fine, coarse
Smooth, rough
Transparent (colorless), opaque
2D shape: flat (horizontal), peak (vertical), angular, round
3D shape: cubic, spherical, hexahedral, polygonal
Hot, warm, moderate, cold
Plain (simple), complex˜in gray scale
Monotone, colorful
Moving, still
Dense (coherent), sparse
Sunny, rainy, gloomy, snowy, foggy, icy

However, the adjective hint item is not limited to these examples and is not limited to English or Korean such that any language can be used.

The adverb hint item (Adverb hint) 720 is semantic information indicating the degree of an adjective hint item. The adverb hint item can have the following values:
Little/few, a little/few (slightly, small)
Normally (ordinarily)
Strongly (greatly, so much/many, pretty)
Percentage: 0˜100%

However, the adverb hint item is not limited to these examples and is not limited to English or Korean such that any language can be used.

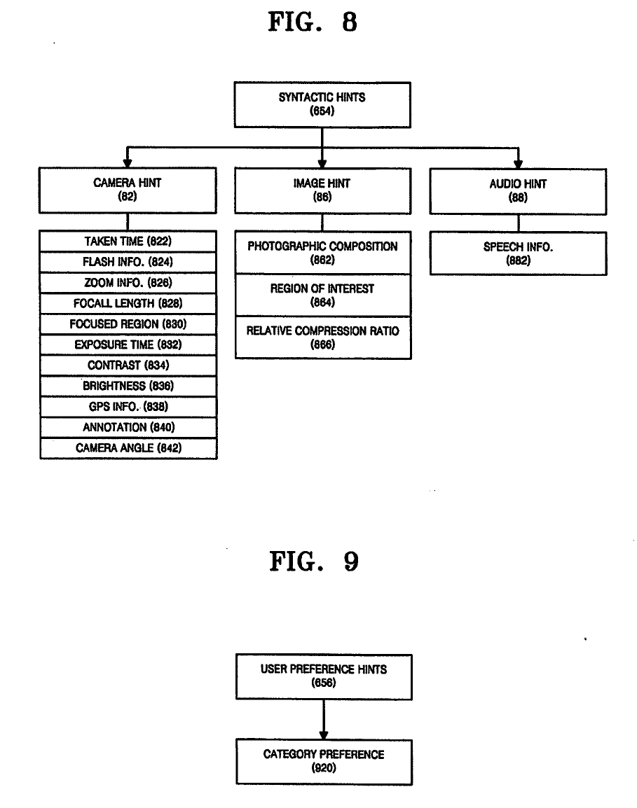

FIG. 8 is a block diagram showing syntactic hint information among hint information items required for effective photo categorizing described in FIG. 6. As shown in FIG. 8, the hint item (Syntactic hints) 654 that can be extracted from forming information of an object in the contents of the photo and camera information and/or photographing information of the photo, or can be extracted from interaction with a user, includes a hint item (Camera hints) 82 of camera information at the time of photographing, a hint item (Image hints) 86 on a syntactic element included in object forming information in the contents of a photo, and a hint item (Audio hints) 88 on an audio clip that is stored together when the photo is taken.

The hint item (Camera hints) 82 of camera information at the time of photographing is based on EXIF information stored in a photo file and may include a photographing time (Taken time) 822, information (Flash info) 824 on whether or not a flash is used, information (Zoom info) 826 on whether or not a camera zoom is used and the zoom distance, a camera focal length (Focal length) 828, a focused region (Focused region) 830, an exposure time (Exposure time) 832, information (Contrast) 834 on contrast basically set for the camera, information (Brightness) 836 on brightness basically set for the camera, GPS information (GPS info) 838, text annotation information (Annotation) 840, and camera angle information (Angle) 842. The hint item of camera information at the time of photographing is based on the EXIF information but not limited to these examples.

The hint item (Image hints) 86 on a syntactic element included in the photo may include information (Photographic composition) 862 on a composition formed by objects of the photo, information (Region of interest) 864 on the number of main interest areas in the photo and the location of each area, and a relative compression ratio (Relative compression ratio) 866 in relation to the resolution of the photo. However, the hint item on the syntactic element included in the photo is not limited to these examples.

The hint item (Audio hints) 88 on the stored audio clip may include an item (Speech info) 882 describing speech information extracted from the audio clip with keywords. However, it is not limited to this example.

FIG. 9 is a block diagram showing user preference hint information among hint information items required for effective photo categorizing described in FIG. 6. Referring to FIG. 9, the hint item (User preference hints) 656 describing the personal preference of the user in categorizing photos has a hint item (Category preference) 920 describing the preference of the user of the categories in a category list. Generally, in many cases, users roughly remember the categories of photos to be categorized. Accordingly, based on the memory of a user, a higher weight value may be given to categories to which most photos belong, with a lower weight value being given to categories to which less photos belong. However, the hint item describing the personal preference of the user is not limited to this example.

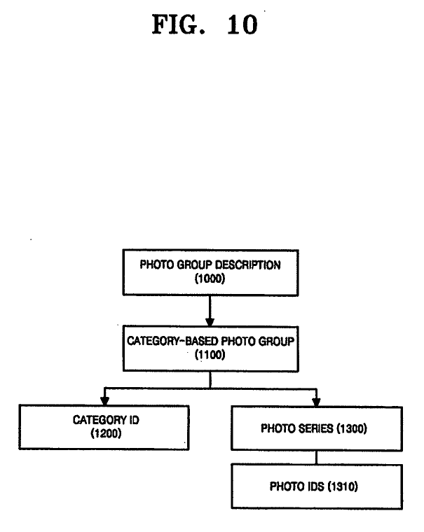

FIG. 10 is a block diagram showing a description scheme 1000 to express photo group information after clustering photos. A photo group includes a category-based photo group 1100, and each category includes a lower level group (Photo series) 1300 and has a category identifier (Category ID) 1200 and is referred to by a category list. Each photo group can include a plurality of photos as photo identifiers (Photo ID) 1310.

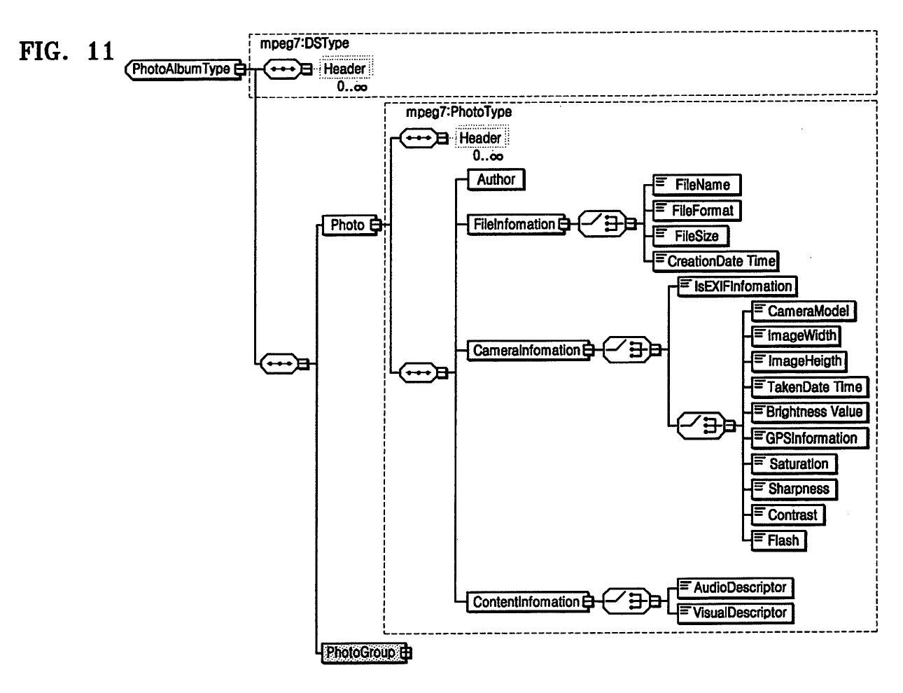

A description scheme expressing camera information and photographing information stored in a photo file and content-based feature value information extracted from the content of the photo can be expressed in an XML format as the following. FIG. 11 is a block diagram showing a photo information description scheme according to an embodiment of the present invention expressed in an XML schema.

```
<complexType name=“PhotoType”>
  <complexContent>
    <extension base=“mpeg7:DSType”>
      <sequence>
        <element name=“Author” type=“mpeg7:TextualType”/>
        <element name=“FileInfomation”>
          <complexType>
            <complexContent>
              <extension base=“mpeg7:DType”>
                <sequence>
                  <element name=“FileName” type=“mpeg7:TextualType”/>
                  <element name=“FileFormat” type=“mpeg7:TextualType”/>
                  <element name=“FileSize” type=“nonNegativeInteger”/>
                  <element name=“CreationDateTime”
type=“mpeg7:timePointType”/>
                </sequence>
              </extension>
            </complexContent>
          </complexType>
        </element>
        <element name=“CameraInfomation”>
          <complexType>
            <choice>
              <element name=“IsEXIFInfomation” type=“boolean”/>
              <sequence>
                <element name=“CameraModel” type=“mpeg7:TextualType”/>
                <element name=“ImageWidth” type=“nonNegativeInteger”/>
                <element name=“ImageHeight” type=“nonNegativeInteger”/>
                <element name=“TakenDateTime” type=“mpeg7:timePointType”/>
                <element name=“BrightnessValue” type=“integer”/>
                <element name=“GPSInfomation” type=“nonNegativeInteger”/>
                <element name=“Saturation” type=“integer”/>
                <element name=“Sharpness” type=“integer”/>
                <element name=“Contrast” type=“integer”/>
                <element name=“Flash” type=“boolean”/>
              </sequence>
            </choice>
          </complexType>
        </element>
        <element name=“ContentInfomation”>
          <complexType>
            <complexContent>
              <extension base=“mpeg7:DType”>
                <sequence>
                  <element name=“VisualDescriptor” type=“mpeg7:VisualDType”/>
                  <element name=“AudioDescriptor” type=“mpeg7:AudioDType”/>
                </sequence>
            </extension>
            </complexContent>
          </complexType>
        </element>
      </sequence>
      <attribute name=“PhotoID” type=“ID” use=“required”/>
    </extension>
  </complexContent>
      </complexType>
```

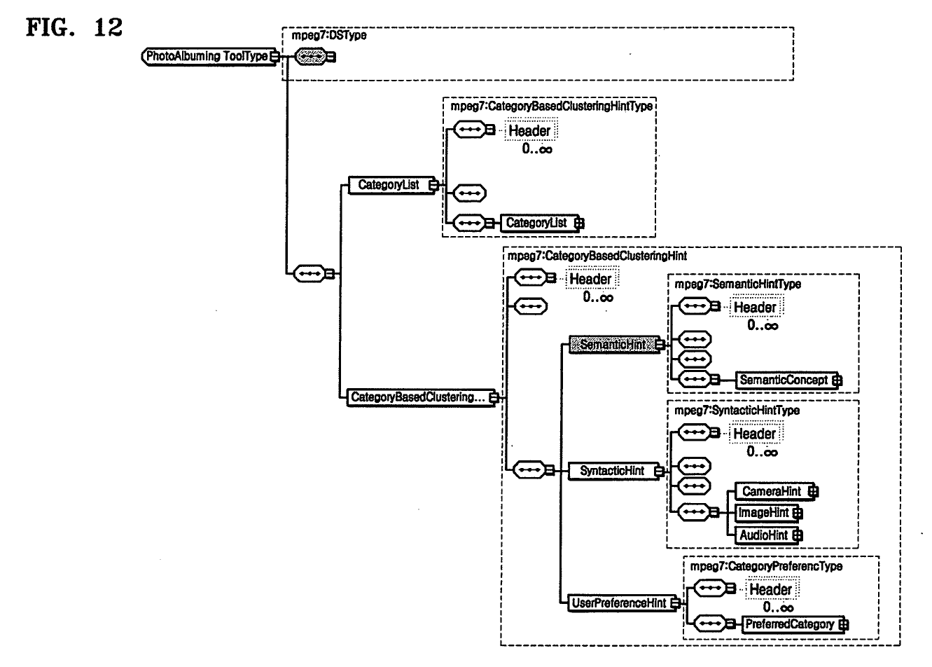

Also, a description scheme expressing parameters required for effective photo clustering can be expressed in an XML format as the following, and FIG. 12 is a block diagram showing a parameter description scheme for photo albuming according to an embodiment of the present invention expressed in an XML schema:

```
<complexType name=“PhotoAlbumingToolType”>
  <complexContent>
    <extension base=“mpeg7:PhotoAlbumingToolType”>
      <sequence>
        <element name=“CategoryList” type=“mpeg7:PhotoCategoryListType”/>
        <element name=“CategoryBasedClusteringHint”
type=“mpeg7:CategoryBasedClusteringHintType”/>
      </sequence>
    </extension>
  </complexContent>
</complexType>
<complexType name=“PhotoCategoryListType”>
  <complexContent>
    <extension base=“mpeg7:PhotoAlbumingToolType”>
      <sequence>
        <element name=“CategoryList” type=“mpeg7:ControlledTermUseType”/>
      </sequence>
    </extension>
  </complexContent>
</complexType>
<complexType name=“CategoryBasedClusteringHintType”>
  <complexContent>
    <extension base=“mpeg7:PhotoAlbumingToolType”>
      <sequence>
        <element name=“SemanticHint” type=“mpeg7:SemanticHintType”/>
        <element name=“SyntacticHint” type=“mpeg7:SyntacticHintType”/>
        <element name=“UserPreferenceHint” type=“mpeg7:CategoryPreferenceType”/>
      </sequence>
    </extension>
  </complexContent>
</complexType>
<complexType name=“SyntacticHintType”>
  <complexContent>
    <extension base=“mpeg7:CategoryBasedClusteringHintType”>
      <sequence>
        <element name=“CameraHint” type=“mpeg7:CameraHintType”/>
        <element name=“ImageHint” type=“mpeg7:ImageHintType”/>
        <element name=“AudioHint” type=“mpeg7:AudioHintType”/>
      </sequence>
    </extension>
  </complexContent>
</complexType>
<complexType name=“SemanticHintType”>
  <complexContent>
    <extension base=“mpeg7:CategoryBasedClusteringHintType”>
    <sequence>
        <element name=“SemanticConcept”>
          <complexType>
            <complexContent>
              <extension base=“mpeg7:DType”>
                <sequence>
                  <element name=“Adverb” type=“mpeg7:ControlledTermUseType”/>
                  <element name=“Adjective”
type=“mpeg7:ControlledTermUseType”/>
                  <element name=“Noun” type=“mpeg7:ControlledTermUseType”/>
                </sequence>
              </extension>
            </complexContent>
          </complexType>
        </element>
      </sequence>
    </extension>
  </complexContent>
</complexType>
<complexType name=“UserPreferenceHintType”>
  <complexContent>
    <extension base=“mpeg7:CategoryBasedClusteringHintType”>
      <sequence>
        <element name=“CategoryPreference” type=“mpeg7:PhotoCategoryListType”/>
      </sequence>
      <attribute name=“ImportanceValue” type=“mpeg7:zeroToOneType” use=“required”/>
    </extension>
  </complexContent>
</complexType>
<complexType name=“AudioHintType”>
  <complexContent>
    <extension base=“mpeg7:SyntacticHintType”>
      <sequence>
        <element name=“Timbre” type=“mpeg7:TextualType”/>
        <element name=“RecognizedKeyword” type=“mpeg7:TextualType”/>
      </sequence>
    </extension>
  </complexContent>
</complexType>
<complexType name=“ImageHintType”>
  <complexContent>
    <extension base=“mpeg7:SyntacticHintType”>
      <sequence>
        <element name=“PhotographicComposition”>
          <complexType>
            <complexContent>
              <extension base=“mpeg7:DType”>
                <sequence>
                  <element name=“MainSubjectPosition”>
                    <simpleType>
                      <restriction base=“string”>
                        <enumeration value=“Center”/>
                        <enumeration value=“leftTop”/>
                        <enumeration value=“rightTop”/>
                        <enumeration value=“leftBottom”/>
                        <enumeration value=“rightBottom”/>
                        <enumeration value=“noMainSubject”/>
                      </restriction>
                    </simpleType>
                  </element>
                  <element name=“OverallComposition”>
                    <simpleType>
                      <restriction base=“string”>
                        <enumeration value=“Triangle”/>
                        <enumeration value=“invertedTriangle”/>
                        <enumeration value=“Circle”/>
                        <enumeration value=“Rectangle”/>
                        <enumeration value=“Vertical”/>
                        <enumeration value=“Horizontal”/>
                        <enumeration value=“Incline”/>
                        <enumeration value=“Curve”/>
                      </restriction>
                    </simpleType>
                  </element>
                </sequence>
              </extension>
            </complexContent>
          </complexType>
        </element>
        <element name=“RegionOfInterest” type=“mpeg7:RegionLocatorType”/>
        <element name=“SituationBasedClusterInfo” type=“IDREF”/>
        <element name=“RelativeCompressionRatio” type=“mpeg7:zeroToOneType”/>
      </sequence>
    </extension>
  </complexContent>
</complexType>
<complexType name=“CameraHintType”>
  <complexContent>
    <extension base=“mpeg7:SyntacticHintType”>
      <sequence>
        <element name=“TakenTime” type=“mpeg7:timePointType”/>
        <element name=“Annotation” type=“mpeg7:TextualType”/>
        <element name=“ColorDepth” type=“nonNegativeInteger”/>
        <element name=“CameraZoom” type=“mpeg7:zeroToOneType”/>
        <element name=“CameraFlash” type=“boolean”/>
        <element name=“ExposureTime” type=“nonNegativeInteger”/>
        <element name=“CameraContrastValue” type=“mpeg7:zeroToOneType”/>
        <element name=“CameraSharpnessValue” type=“mpeg7:zeroToOneType”/>
        <element name=“CameraBrightnessValue” type=“mpeg7:zeroToOneType”/>
        <element name=“CameraAngle”>
          <complexType>
            <complexContent>
              <extension base=“mpeg7:DType”>
                <sequence>
                  <element name=“upDown”>
                    <simpleType>
                      <restriction base=“string”>
                        <enumeration value=“Upward”/>
                        <enumeration value=“Downward”/>
                      </restriction>
                    </simpleType>
                  </element>
                  <element name=“leftRight”>
                    <simpleType>
                      <restriction base=“string”>
                        <enumeration value=“Leftward”/>
                        <enumeration value=“Rightward”/>
                      </restriction>
                    </simpleType>
                  </element>
                </sequence>
              </extension>
            </complexContent>
          </complexType>
        </element>
        <element name=“FocusedRegion”>
          <simpleType>
            <restriction base=“string”>
              <enumeration value=“Foreground”/>
              <enumeration value=“Background”/>
            </restriction>
          </simpleType>
        </element>
        <element name=“GPSInformation” type=“mpeg7:timePointType”/>
      </sequence>
    </extension>
  </complexContent>
</complexType>
```

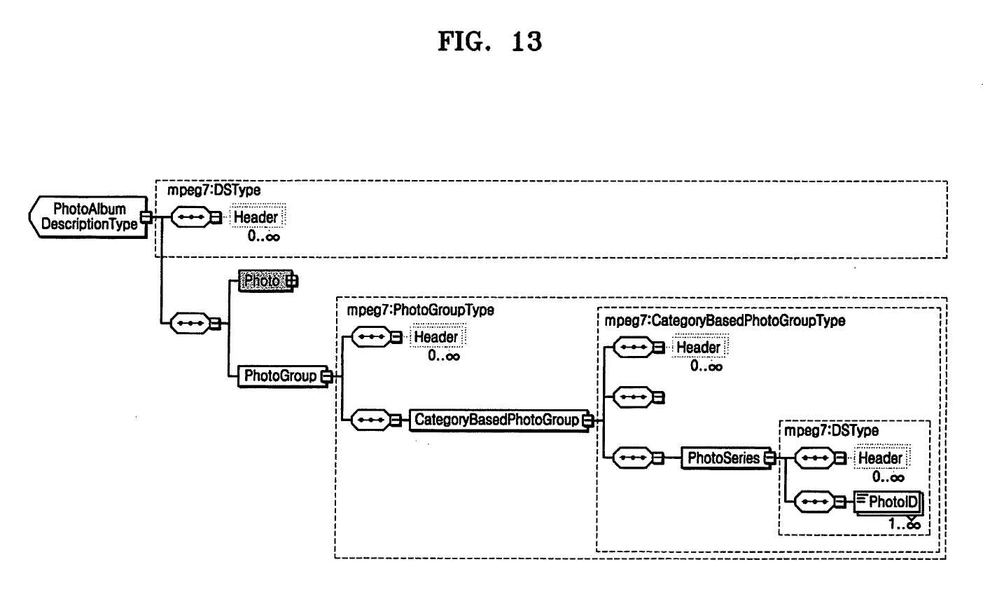

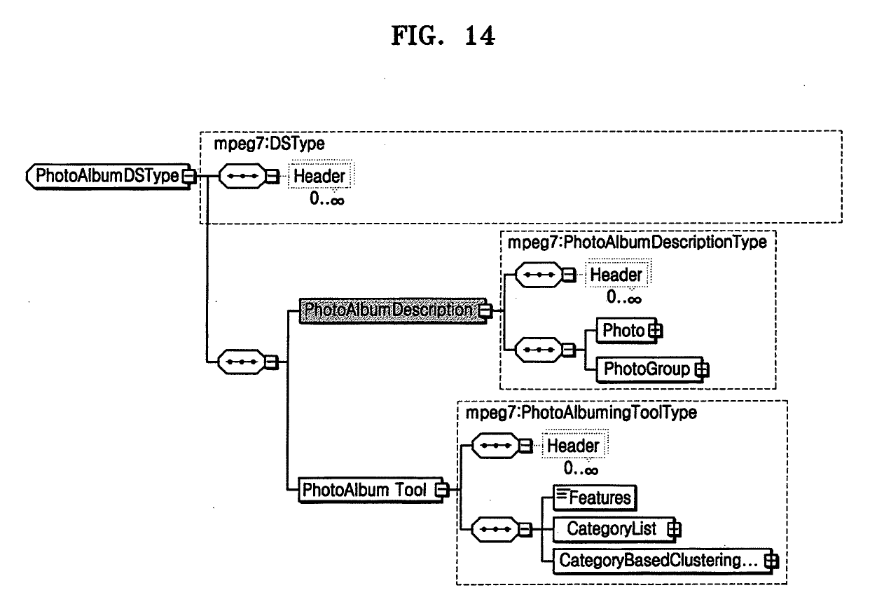

Also, a description scheme expressing photo group information after photo clustering can be expressed in an XML format as the following and FIG. 13 is a block diagram showing a photo group description scheme according to an embodiment of the present invention expressed in an XML schema:

```
<complexType name=“PhotoGroupType”>
  <complexContent>
    <extension base=“mpeg7:DSType”>
      <sequence>
        <element name=“CategoryBasedPhotoGroup”
type=“mpeg7:CategoryBasedPhotoGroupType”/>
      </sequence>
    </extension>
  </complexContent>
</complexType>
<complexType name=“CategoryBasedPhotoGroupType”>
  <complexContent>
    <extension base=“mpeg7:PhotoGroupType”>
      <sequence>
        <element name=“PhotoSeries”>
          <complexType>
            <complexContent>
              <extension base=“mpeg7:DSType”>
                <sequence>
                  <element name=“PhotoID” type=“IDREF”
maxOccurs=“unbounded”/>
                </sequence>
              </extension>
            </complexContent>
          </complexType>
        </element>
      </sequence>
      <attribute name=“CategoryID” type=“IDREF” use=“required”/>
    </extension>
  </complexContent>
</complexType>
```

Also, in order to integrally express the description schemes described above, an entire description scheme for digital photo albuming can be expressed in an XML format as the following and FIG. 14 is a block diagram showing an entire description scheme for digital photo albuming according to an embodiment of the present invention expressed in an XML schema:

```
<schema targetNamespace=“urn:mpeg:mpeg7:schema:2001”
xmlns=“http://www.w3.org/2001/XMLSchema”
xmlns:mpeg7=“urn:mpeg:mpeg7:schema:2001”
elementFormDefault=“qualified” attributeFormDefault=“unqualified”>
  <annotation>
    <documentation>
    This document contains visual tools defined in ISO/IEC 159”-3
    </documentation>
  </annotation>
  <include schemaLocation=“./mds-2001.xsd”/>
  <complexType name=“PhotoAlbumDSType”>
    <complexContent>
      <extension base=“mpeg7:DSType”>
        <sequence>
          <element name=“PhotoAlbumDescription”
          type=“mpeg7:PhotoAlbumType”/>
          <element name=“AlbumingToolDescription”
type=“mpeg7:PhotoAlbumingToolType”/>
        </sequence>
      </extension>
    </complexContent>
  </complexType>
  <complexType name=“PhotoAlbumType”>
    <complexContent>
      <extension base=“mpeg7:DSType”>
        <sequence>
          <element name=“Photo” type=“mpeg7:PhotoType”/>
          <element name=“PhotoGroup”
          type=“mpeg7:PhotoGroupType”/>
        </sequence>
      </extension>
    </complexContent>
  </complexType>
</schema>
```

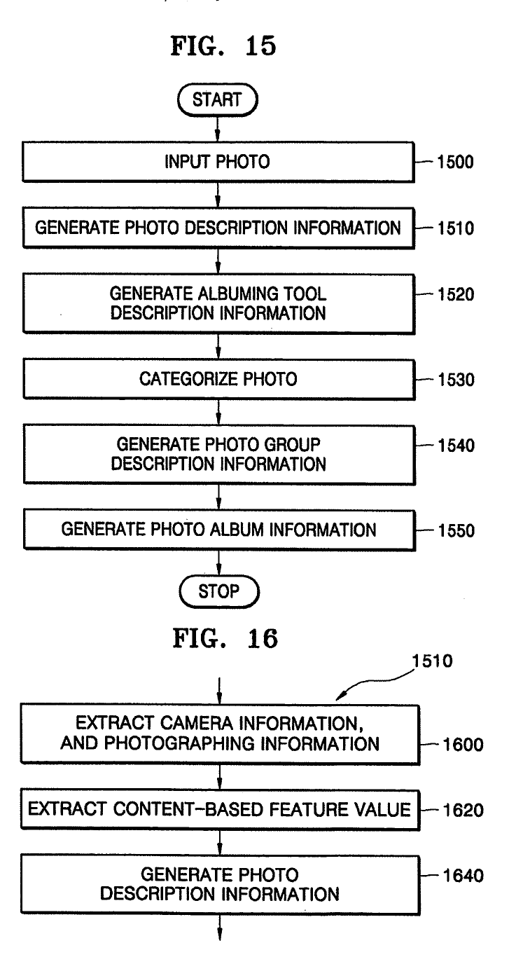

Meanwhile, FIG. 15 is a flowchart of the operations performed by a method of category-based photo clustering according to an embodiment of the present invention. Referring to FIG. 15, the operation of an apparatus for category-based photo clustering according to an embodiment of the present invention will now be explained.

The apparatus for and method of category-based photo clustering according to an embodiment of the present invention effectively produce a digital photo album with digital photo data, by using the information described above. Accordingly, first, if a photo is input through the photo input unit 100 in operation 1500, photo description information describing the photo and including at least a photo identifier is generated in operation 1510.

Also, albuming tool description information supporting photo categorization and including at least a predetermined parameter for photo categorization is generated in operation 1520. Then, by using the input photo, the photo description information and the albuming tool description information, categorization of the photo is performed in operation 1530. The categorized result is generated as predetermined photo group description information in operation 1540. By using the photo description information and the photo group description information, predetermined photo album information is generated in operation 1550.

FIG. 16 is a detailed flowchart of the operations performed in the operation 1500 of FIG. 15. Generation of photo description information will now be explained with reference to FIG. 16. From a photo file, camera information of the camera used to take the photo and photographing information on the photographing are extracted in operation 1600. From pixel information of the photo, a predetermined content-based feature value is extracted in operation 1620. By using the extracted camera information, photographing information and the content-based feature value, predetermined photo description information is generated in operation 1640.

The content-based feature value includes a visual descriptor including color, texture, and shape feature values, and an audio descriptor including a speech feature value. The photo description information includes at least a photo identifier among the photo identifier, information on the photographer taking the photo, photo file information, the camera information, the photographing information, and the content-based feature value.

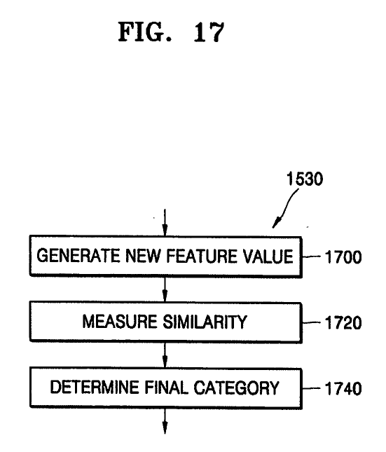

FIG. 17 is a detailed flowchart of the operations performed in the operation 1530 of FIG. 15. Photo categorization will now be explained with reference to FIG. 17. First, by applying the category-based clustering hint to the extracted content-based feature value, a new feature value is generated in operation 1700. The similarity distance values between the new feature value and feature values in a predetermined category feature value database are measured in operation 1720. One or more categories satisfying a condition that the similarity distance value is less than a predetermined threshold are determined as final categories in operation 1740.

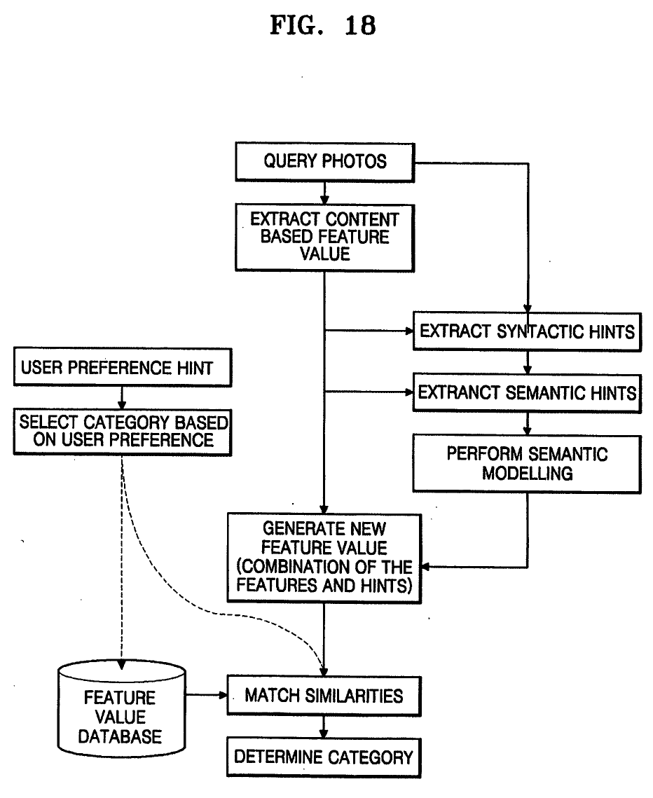

FIG. 18 illustrates a method of category-based clustering of an arbitrary photo according to an embodiment of the present invention. In order to categorize input photos, first, it is assumed that there are C categories in a photo album. A category set in the photo album is expressed as the following equation 1:
S_{category}={S₁,S₂,S₃, . . . ,S_{c}, . . . ,S_{C}} (1)

Here, S_{c} denotes an arbitrary c-th category.

An embodiment of the present invention is a method of automatically clustering a large volume of input photo data into C categories, and includes the operations described below.

First, with respect to a user profile, such as the age, sex, usage habit, and usage history, respective categories of input query photos are determined, and are determined by the XML expression described above and the ‘user preference hint’ in FIG. 11. The user preference on a category indicates user category preference hints of the user as the following.
Vᵤₛₑᵣ={β₁,β₂,β₃, . . . ,β_{c}, . . . ,β_{C}} (2)

Here, β_{c} is a value denoting the preference degree of the user on the c-th category and has a value between 0.0 to 1.0 inclusive.

A method of selecting a category by the equation 2 can be expressed as the following equation 3:
S_{category}^{selected}={β₁S₁,β₂S₂,β₃S₃, . . . ,β_{c}S_{c}, . . . ,β_{C}S_{C}} (3)

Here, S_{c} denotes the c-th category, and if β_{c} is 0.0, the category is not selected, and if β_{c} is close to 0.0, the category is selected but it indicates the user preference of the category is low. If β_{c} is close to 1.0, it indicates that the user preference of the selected category is high.

Next, a syntactic hint item is extracted by using the EXIF information, image composition information, and audio clip information stored in the camera. The syntactic hint extracted from an i-th photo among query photos is expressed as the following equation 4:
V_{syntactic}(i)={V_{camera}, V_{image}, V_{audio}} (4)

Here, V_{camera} denotes a set of syntactic hints including camera information and photographing information, V_{image} denotes a set of syntactic hints extracted from photo data itself, and V_{audio} denotes a set of syntactic hint values extracted from the audio clip stored together with photos.

Next, by using the syntactic hint values, an image is localized and from each area, multiple content-based feature values are extracted. Multiple content-based feature values in a j-th area of the i-th photo is expressed as the following equation 5:
F_{content}(i,j)={F₁(i,j),F₂(i,j),F₃(i,j), . . . ,F_{N}(i,j)} (5)

Here, Fₖ(i,j) denotes a k-th feature value vector in the j-th area of the i-th photo, and can include color, texture, or shape feature value.

Next, a semantic hint value is extracted from each area. M semantic hints extracted from the j-th area of the i-th photo can be expressed as the following equation 6:
V_{semantic}(i,j)={V₁, V₂, V₃, . . . , V_{M}} where Vₘ=(νₘ^{adverb}, νₘ^{adjective}, νₘ^{noun}, αₘ) (6)

Here, Vₘ denotes an m-th semantic hint value extracted in the j-th area of the i-th photo, νₘ^{noun} denotes the m-th noun hint value, νₘ^{adverb} denotes the m-th adverb hint value, νₘ^{adjective} denotes the m-th adjective hint value, and αₘ denotes a value indicating the importance of the m-th semantic hint value, and has a value between 0.0 and 1.0 inclusive.

The thus extracted syntactic, semantic, and user preference hint values can be expressed together as the following equation 7:
Vₕᵢₙₜ(i)={V_{semantic}(i), V_{syntactic}(i), Vᵤₛₑᵣ} (7)

Here, V_{semantic}(i) denotes the semantic hint extracted from the i-th photo, V_{syntactic}(i) denotes the syntactic hint extracted from the i-th photo, and Vᵤₛₑᵣ(i) denotes the user category preference hint.

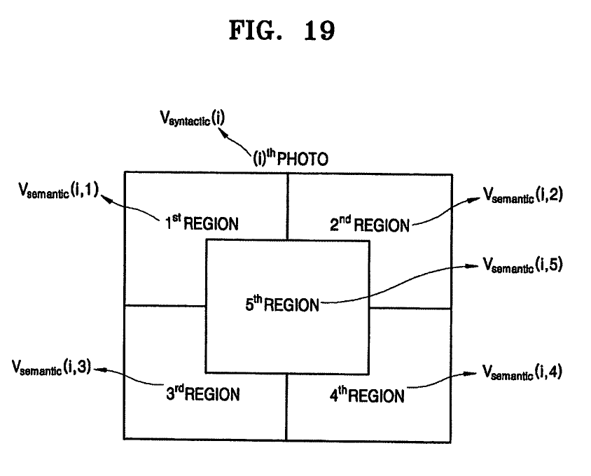

FIG. 19 illustrates an example of category-based clustering hint extraction suggested in an embodiment of the present invention. Referring to FIG. 19, the i-th photo is formed with five areas in total, and each area has a semantic hint value. Irrespective of the areas, the photo has a syntactic hint on the entire contents of the photo.

By applying the category-based clustering hints to extracted content-based feature value information, a new feature value is generated. The new generated feature value is expressed as the following equation 8:
F_{combined}(i)=Φ{Vₕᵢₙₜ(i),F_{content}(i)} (8)

Here, function Φ(·) is a function generating a feature value by using together Vₕᵢₙₜ(i), the category-based clustering hint of the i-th photo, and F_{content}(i), the content-based feature value of the i-th photo. The function Φ(·) can be defined, for example, as the following equation 9:

$$Φ \{ {V}_{hint} ( i ) , {F}_{content} ( i ) \} = \{ {\sum }_{j}^{} {V}_{semantic} ( i , j ) \cdot {V}_{stnthetic} ( i , j ) \cdot {F}_{1} ( i , j ) , {\sum }_{j}^{} {V}_{semantic} ( i , j ) \cdot {V}_{stnthetic} ( i , j ) \cdot {F}_{2} ( i , j ) , … , {\sum }_{j}^{} {V}_{semantic} ( i , j ) \cdot {V}_{stnthetic} ( i , j ) \cdot {F}_{1} ( i , j ) , {\sum }_{j}^{} {V}_{semantic} ( i , j ) \cdot {V}_{stnthetic} ( i , j ) \cdot {F}_{N} ( i , j ) \} \qquad ( 9 )$$

However, for the function Φ(·) which obtains the final feature value F_{combined}(i) from the category hints, methods such as neural network, Bayesian learning, support vector machine (SVM) learning, and instance-based learning, can be used in addition to equation 9, and are not limited to the above example.

By using the given feature value of the i-th photo, F_{combined}(i), similarity distance values between the feature values of the model database of each category already stored and indexed in each category, and the i-th photo are measured. In order to measure the similarity distance value, first it is assumed that there are C categories in the database. The model database of each category stores feature values extracted from images categorized and stored. P features values stored in the c-th category model database, F_{database}(c), can be expressed as the following equation 10:
F_{database}(c)={F_{database}(c,1),F_{database}(c,2),F_{database}(c,3), . . . ,F_{database}(c,P)} (10)

The similarity distance value between the feature value of the i-th photo and the feature value stored in the model database of each category is expressed as the following equation 11:
D(i)={D₁(i), D₂(i), D₃(i), . . . , D_{c}(i)} (11)

Here, Dc(i) denotes the similarity distance value between the c-th category and the i-th photo, and can be obtained according to the following equation 12:

$${D}_{c} ( i ) = \frac{distance ( {F}_{combined} ( i ) , {F}_{database} ( c ) )}{k ( 1 + {V}_{user} ( c ) )} = \frac{distance ( {F}_{combined} ( i ) , {F}_{database} ( c ) )}{k ( 1 + {β}_{c} )} \qquad ( 12 )$$

Here, distance(·) is a function measuring the similarity distance value between a query photo and feature values of a category database, and k denotes an integer weighting the influence of the user preference β_{c} on the category.

The final category of the i-th photo can be determined as one or more categories satisfying the following equation 13:
S_{target}(i) ⊂ {S₁,S₂,S₃, . . . ,S_{C}}, subject to D_{S}_{_{c}}(i)≦th_{D} (13)

Here, {S₁, S₂, S₃, . . . , S_{c}} denotes a set of categories, th_{D} denotes a threshold of a similarity distance value for determining a category, and S_{target}(i) denotes a set of categories satisfying the condition and indicates the category of the i-th photo.

The present invention can also be embodied as computer (including all apparatuses having an information processing function) readable codes on one or more computer readable recording media. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

According to the method of and system for category-based photo clustering in a digital photo album according to the embodiments of the present invention, by using together user preference and content-based feature value information, such as color, texture, and shape, from the contents of photos, as well as information that can be basically obtained from photos, such as camera information and file information stored in a camera, a large volume of photos are effectively categorized such that an album can be quickly and effectively generated with photo data. Moreover, while described in terms of a photo, it is understood that aspects of the invention can be implemented for use with video, such as through analysis of frames in the video.

It is understood that aspects of the present invention can also be implemented in a camera, PDA, telephone or any other apparatus that includes a monitor or display.

While the present invention has been particularly shown and described with reference to exemplary embodiments thereof, it will be understood by those of ordinary skill in the art that various changes in form and details may be made therein without departing from the spirit and scope of the present invention as defined by the following claims. The embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of category-based clustering in a digital photo album, comprising:
generating photo information by extracting at least one of camera information of a camera used to take a photo, photographing information, and a content-based feature value of the photo including at least one of color, texture, and shape feature values, a speech feature value, or combinations thereof;
generating a predetermined parameter including at least one of user preference indicating a personal preference of the user, photo semantic information generated by using the content-based feature value of the photo, photo syntactic information or combinations thereof, with the photo syntactic information being generated by at least one of the camera information, the photographing information, interaction with the user or combinations thereof;
generating photo group information categorizing photos by using the photo information and the predetermined parameter; and
generating a photo album by using the photo information and the photo group information.

2. A method of category-based clustering in a digital photo album, comprising:
generating photo description information describing a photo and including at least a photo identifier;
generating albuming tool information supporting photo categorization and including at least a predetermined parameter for photo categorization;
categorizing photos by using input photos, the photo description information and the albuming tool information;
generating the categorized result as predetermined photo group description information; and
generating predetermined photo album information by using the photo description information and the predetermined photo group description information.

3. The method of claim 2, wherein the generating of the photo description information comprises:
extracting camera information of a camera used to take the photo and photographing information from a photo file;
extracting a content-based feature value from pixel information of the photo; and
generating photo description information by using the extracted camera information, photographing information and content-based feature value, and
the content-based feature value comprises:
a visual descriptor including color, texture, and shape feature values; and
an audio descriptor including a speech feature value, and
the photo description information comprises at least the photo identifier, information of a photographer taking the photo, photo file information, the camera information, the photographing information, and the content-based feature value.

4. The method of claim 3, wherein the photo file information comprises at least one of a file name, file format, file size, file creation date, or combinations thereof, and
the camera information comprises at least one of information (IsEXIFInformation) indicating whether or not the photo file includes EXIF information, information (Camera model) indicating a camera model used to take the photo, or combinations thereof, and
the photographing information comprises at least one of information (Taken date/time) indicating a date and time when the photo is taken, information (GPS information) indicating a location where the photo is taken, photo width information (Image width), photo height information (Image height), information (Flash on/off) indicating whether or not a camera flash is used to take the photo, brightness information of the photo (Brightness), contrast information of the photo (Contrast), sharpness information of the photo (Sharpness), or combinations thereof.

5. The method of claim 3, wherein in the generating of the albuming tool information, the albuming tool description information comprises at least one of:
a category list indicating semantic information to be categorized;
a category-based clustering hint to help photo clustering, or combinations thereof, and
the category-based clustering hint comprises at least one of:
a semantic hint generated by using the content-based feature value of the photo;
a syntactic hint generated by at least one of the camera information, the photographing information and interaction with a user;
a user preference hint, or combinations thereof.

6. The method of claim 5, wherein the category list comprises at least one of mountain, waterside, human-being, indoor, building, animal, plant, transportation, object, or combinations thereof.

7. The method of claim 5, wherein the semantic hint is semantic information included in the photo, the information expressed by using nouns, adjectives, and adverbs.

8. The method of claim 5, wherein the syntactic hint comprises at least one of:
a camera hint indicating the camera information at the time of photographing;
an image hint including at least one of information (Photographic composition) on a composition formed by objects of the photo, information (Region of interest) of a number of main interest areas in the photo and a location of each area, a relative compression ratio (Relative compression ratio) in relation to the resolution of the photo, or combinations thereof;
an audio hint including keywords (Speech info) describing speech information extracted from an audio clip, or combinations thereof.

9. The method of claim 8, wherein the camera hint is based on EXIF information stored in a photo file and comprises at least one of a photographing time (Taken time), information (Flash info) on whether or not a flash is used, information (Zoom info) on whether or not a camera zoom is used and the zoom distance, a camera focal length (Focal length), a focused region (Focused region), an exposure time (Exposure time), information (Contrast) on contrast basically set for the camera, information (Brightness) on brightness basically set for the camera, GPS information (GPS info), text annotation information (Annotation), camera angle information (Angle), or combinations thereof.

10. The method of claim 5, wherein the user preference hint comprises:
category preference information (Category preference) describing a preference of the user on categories in the category list.

11. The method of claim 5, wherein the categorizing of the photos comprises:
generating a new feature value by applying the category-based clustering hint to the extracted content-based feature value;
measuring similarity distance values between the new feature value and feature values in a predetermined category feature value database; and
determining one or more categories satisfying a condition that a similarity distance value is less than a predetermined threshold, as final categories.

12. The method of claim 11, wherein the semantic hint, the syntactic hint and the user preference hint values are extracted and a value of the category-based clustering hint is expressed as the following equation:
Vₕᵢₙₜ(i)={V_{semantic}(i), V_{syntactic}(i), Vᵤₛₑᵣ}
where V_{semantic}(i) denotes a semantic hint extracted from the i-th photo, V_{syntactic}(i) denotes a syntactic hint extracted from the i-th photo, and Vᵤₛₑᵣ denotes a user category preference hint.

13. The method of claim 12, wherein in the user preference hint value extraction, a category on which sets of input query photo data belong is selected according to a memory of the user, an importance degree of each category is input, and the category preference hint of the user is expressed as the following equation:
Vᵤₛₑᵣ={β₁,β₂,β₃, . . . ,β_{c}, . . . ,β_{C}}
where β_{c} is a value denoting the preference degree of the user on a c-th category and has a value between 0.0 to 1.0 inclusive, and a method of selecting a category by the above equation is expressed as the following equation:
S_{category}^{selected}={β₁S₁,β₂S₂,β₃S₃, . . . ,β_{c}S_{c}, . . . ,β_{C}S_{C}}
where S_{c} denotes the c-th category, and if β_{c} is 0.0, the category is not selected, and if β_{c} is close to 0.0, the category is selected but indicates the user preference of the category is low, and if β_{c} is close to 1.0, β_{c} indicates that the user preference of the selected category is high.

14. The method of claim 12, wherein in the extraction of the syntactic hint value, by using EXIF information, image composition information, and audio clip information stored in the camera, the semantic hint value is extracted and the semantic hit value extracted from an i-th photo is expressed as the following equation:
V_{syntactic}(i)={V_{camera}, V_{image}, V_{audio}}
where V_{camera} denotes a set of syntactic hints including camera information and photographing information, V_{image} denotes a set of syntactic hints extracted from photo data itself, and V_{audio} denotes a set of syntactic hint values extracted from an audio clip stored together with photos.

15. The method of claim 12, wherein in the extraction of the semantic hint value, a semantic hint value included in the contents of the photo is extracted in a j-th area of the i-th photo, and is expressed as the following equation:
V_{semantic}(i,j)={V₁, V₂, V₃, . . . , V_{M}} where Vₘ=(νₘ^{adverb}, νₘ^{adjective}, νₘ^{noun}, αₘ)
where Vₘ denotes an m-th semantic hint value extracted in the j-th area of the i-th photo, νₘ^{noun} denotes the m-th noun hint value, νₘ^{adverb} denotes the m-th adverb hint value, νₘ^{adjective} denotes the m-th adjective hint value, and αₘ denotes a value indicating the importance of the m-th semantic hint value, and has a value between 0.0 and 1.0 inclusive.

16. The method of claim 11, wherein in relation to the content-based feature value, by using extracted category hint information items, an image is localized and from each area, multiple content-based feature values are extracted and multiple content-based feature values in a j-th area of the i-th photo are expressed as the following equation:
F_{content}(i, j)={F₁(i, j), F₂(i, j), F₃(i, j), . . . , F_{N}(i, j)}
where Fₖ(i,j) denotes a k-th feature value vector in the j-th area of the i-th photo.

17. The method of claim 11, wherein in the generating of the new feature value, the new feature value is expressed as the following equation:
F_{combined}(i)=Φ{Vₕᵢₙₜ(i), F_{content}(i)}
where function Φ(·) is a function generating a feature value by using together Vₕᵢₙₜ(i), the category-based clustering hint of the i-th photo, and F_{content}(i), the content-based feature value of the i-th photo, and
in the measuring of the similarity distance value, the similarity distance value is expressed as the following equation:
D(i)={D₁(i), D₂(i), D₃(i), . . . , D_{c}(i)}
where D_{c}(i) denotes the similarity distance value between the c-th category and the i-th photo, and
in the determining one or more categories, the condition is expressed as the following equation:
S_{target}(i) ⊂ {S₁,S₂,S₃, . . . ,S_{C}}, subject to D_{S}_{_{c}}(i)≦th_{D}
where {S₁, S₂, S₃, . . . , S_{c}} denotes a set of categories, th_{D} denotes a threshold of a similarity distance value for determining a category, and S_{target}(i) denotes a set of categories satisfying the condition and indicates the category of the i-th photo.

18. The method of claim 3, wherein in the generating of the categorized result as the predetermined photo group description information, the photo group description information comprises:
a category identifier generated by referring to the category list; and
a series of photos formed with a plurality of photos determined by the photo identifier.

19. An apparatus for category-based clustering in a digital photo album, comprising:
a photo description information generation unit generating photo description information describing a photo and including at least a photo identifier;
an albuming tool description information generation unit generating albuming tool description information supporting photo categorization and including at least a predetermined parameter for the photo categorization;
an albuming tool performing photo albuming including the photo categorization by using at least the photo description information and the albuming tool description information;
a photo group information generation unit generating photo group description information from the photo albuming; and
a photo album information generation unit generating predetermined album information by using the photo description information and the photo group description information.

20. The apparatus of claim 19, wherein the photo description information comprises at least one of a photo identifier among the photo identifier, information on a photographer taking the photo, photo file information, camera information, photographing information, content-based feature value, or combinations thereof, and
the content-based feature value is generated by using pixel information of the photo and comprises:
a visual descriptor including color, texture, and shape feature values; and
an audio descriptor including a speech feature value.

21. The apparatus of claim 19, wherein the albuming tool description information generation unit comprises at least one of:
a category list generation unit generating a category list indicating semantic information to be categorized;
a clustering hint generation unit generating a category-based clustering hint to help photo clustering, or combinations thereof, and
the clustering hint generation unit comprises at least one of:
a semantic hint generation unit generating a semantic hint by using the content-based feature value of the photo;
a syntactic hint generation unit generating a syntactic hint by at least one of the camera information, the photographing information and interaction with a user;
a preference hint generation unit generating a preference hint of the user, or combinations thereof.

22. The apparatus of claim 21, wherein the category list of the category list generation unit comprises at least one of mountain, waterside, human-being, indoor, building, animal, plant, transportation, and object.

23. The apparatus of claim 21, wherein the semantic hint of the semantic hint generation unit is semantic information included in the photo, the semantic information expressed by using nouns, adjectives, and adverbs.

24. The apparatus of claim 21, wherein the syntactic hint of the syntactic hint generation unit comprises at least one of:
a camera hint indicating the camera information at time of photographing;
an image hint including at least one of information (Photographic composition) on a composition formed by objects of the photo, information (Region of interest) on a number of main interest areas in the photo and a location of each main interest area, and a relative compression ratio (Relative compression ratio) in relation to a resolution of the photo; and
an audio hint including keywords (Speech info) describing speech information extracted from an audio clip.

25. The apparatus of claim 19, wherein the albuming tool comprises a category-based photo clustering tool clustering digital photo data based on the category.

26. The apparatus of claim 25, wherein the category-based photo clustering tool comprises:
a feature value generation unit generating a new feature value, by using content-based feature value generated in the photo description information generation unit and category-based clustering hint generated in the albuming tool description information generation unit;
a feature value database extracting in advance and storing feature values of photos belonging to a category;
a similarity measuring unit measuring similarity distance values between a new feature value and feature values in the feature value database; and
a category determination unit determining one or more categories satisfying a condition that the similarity distance value is less than a predetermined threshold, as final categories.

27. The apparatus of claim 19, wherein the photo group description information of the photo group information generation unit comprises:
a category identifier generated by referring to a category list; and
a series of photos formed with a plurality of photos determined by the photo identifier.

28. A computer readable recording medium having embodied thereon a computer program for executing the method of claim 1.

29. A computer readable recording medium having embodied thereon a computer program for executing the method of claims 2.

30. A method of category-based clustering in a digital photo album, comprising:
generating photo description information describing the photo and including at least a photo identifier;
generating albuming tool description information supporting photo categorization and including at least a predetermined parameter for photo categorization;
categorizing the photo using the photo description information and the albuming tool description information;
generating photo group description information from the categorized photo; and
generating predetermined photo album information using the photo description information and the photo group description information.

31. The method of claim 30, wherein the photo description information is generated by extracting camera information, and photographing information from a photo file and by extracting a content-based feature value from pixel information of the photo.

32. The method of claim 31, wherein the content-based feature value includes a visual descriptor including color, texture, and shape feature values, and an audio descriptor including a speech feature value.

33. The method of claim 30, wherein the photo description information includes the photo identifier, photographer information, photo file information, camera information, photographing information and content-based feature value.

34. The method of claim 31, wherein the categorization of the photo includes:
generating a new feature value by applying a category-based clustering hint to the extracted content-based feature value;
measuring similarity distance values between the new feature value and feature values in a predetermined category feature value database; and
determining as final categories one or more categories satisfying a condition that the similarity distance value is less than a predetermined threshold.

35. A camera comprising the apparatus of claim 19.
